(19) United States
(12) Patent Application Publication
(10) Pub. No.: US 2013/0161250 A1
(43) Pub. Date: Jun. 27, 2013

(54) STATIC SEAL WITH INTEGRATED SCREEN OR FILTER ELEMENT

(71) Applicants: Erika Szele, Miskolc (HU); Dietmar Buchen, Koln (DE); Stephane Lamouche, Meyzien (FR)

(72) Inventors: Erika Szele, Miskolc (HU); Dietmar Buchen, Koln (DE); Stephane Lamouche, Meyzien (FR)

(21) Appl. No.: 13/704,734

(22) PCT Filed: Feb. 21, 2011
(86) PCT No.: PCT/EP2011/052514

§ 371 Date: Mar. 7, 2013

(30) Foreign Application Priority Data
Jun. 15, 2010 (DE) 102010030072.1

(51) Int. Cl. F16J 15/02; B01D 35/30

(52) U.S. Cl. CPC F16J 15/02; B01D 35/30
USPC 210/232; 264/259

(57) ABSTRACT

A static seal and method with integrated screen or filter element comprises at least one supporting layer 4, at least one screen 6 or one filter 12, wherein the at least one screen 6 or the at least one filter 12 is arranged close to the at least one supporting layer 4, and wherein an elastomer layer 8 extends over at least a portion of one of the supporting layers 4 and over at least a portion of one of the screens 6 or of one of the filters 12 and connects a supporting layer 4 and a screen 6 or a filter 12 to one another.

The present invention relates to a static seal which is in particular intended for use in the automotive sector and serves for establishing sealing between two engine components, for example, an oil container, a cylinder head, an oil pump or a water pump, or for establishing the sealing in the region of a distributor housing or to form a sealing for an intake manifold.

There are different kinds of static seals.

A first type of seals consists only of elastomer. Such a seal can be produced in a cost-effective manner and generally has good damping properties. However, such a seal is not rigid which makes assembly and, in particular, automated assembly considerably more difficult. In addition, such seals entail the risk that the seal is being destroyed when assembling the parts to be sealed.

Another type of seals is based on a silicone paste which is applied directly onto the surface to be sealed. This seal can be applied by a robot. This seal too is inexpensive but is destroyed after each disassembly.

Another seal comprises a cardboard carrier which is reinforced with fibers and/or elastomer.

Another kind of seals are metal seals. This involves a sheet metal, for example, made of stainless steel, which has a continuous rib as a sealing area so as to give the seal a defined pressure with which a sealing area is pressed onto a sealing surface. In order to protect the sheet metal and to improve the sealing properties, the sheet metal can be coated with elastomer. Such a seal offers acceptable production costs while providing good sealing properties.

Further generic seals are known from the patent specifications EP 1 023 549 and WO 2006/024735.

From U.S. Pat. No. 4,625,979, a cylinder head seal is known which comprises a core which consists of a plurality of layers, for example, a metal layer which is provided on both sides with fiber-like layers based on glass fibers or asbestos which are bound by a polymer. Openings for the passage of fluids are provided, which openings are surrounded by sealing beads from silicone applied by screen printing.

From DE 44 02 399, a cylinder head seal is known which has a metal core onto which sealing parts made of elastomer are applied, wherein each part comprises a net of points and holes in the form of a pyramid. When compressing and depending on the degree of pressing, the elastomer situated in the area of the points can flow into the holes.

It is an object of the invention to provide a method for producing a static seal which comprises a screen or filter element and which can be produced with moderate production costs, and which is suitable for numerous purposes.

According to a first aspect of the present invention, a seal having at least one supporting layer and at least one screen or filter is provided. The at least one supporting layer has at least one passage opening. The supporting layer has in addition a coating from elastomer. At least one screen or filter is arranged here in the at least one passage opening and is connected to at least one supporting layer by a joint from elastomer material and is held in the passage opening in a position-oriented manner.

The screen or the filter is arranged close to at least one supporting layer. The screen or the filter is arranged in close proximity next to a supporting layer, is arranged in a touching manner on a supporting layer, or lies in a suitable recess of a passage opening of the supporting layer. An elastomer layer extends at least over a portion of the supporting layer and at least over a portion of the screen or the filter and forms a joint between these components. The elastomer layer can be hot vulcanized or can be produced by injection molding.

In one embodiment, the joint from elastomer material is designed to be thickened and serves as a sealing element for the passage opening. In this embodiment, sealing the components, which are to be connected to one another through the passage opening, is already achieved by the elastomer by means of which the screen or the filter is fixed in the supporting layer. In this embodiment, the coating from elastomer of the supporting layer in the region of this passage opening serves only for protecting the supporting layer against corrosion or for holding the supporting layer at the respective components to be sealed.

In a further embodiment, the thickened joint from elastomer material is formed integrally with the elastomer coating of a supporting layer. Due to an integral design, the seal can be produced in a process which comprises only one elastomer-processing work step so that production costs can be reduced. Moreover, this embodiment only requires providing a single elastomer material so that storage costs can be reduced.

In another embodiment, the joint or, respectively, the thickened joint from elastomer material is implemented separately from the elastomer coating of the supporting layer. Through this structure, the properties of these components can be controlled better. This embodiment also allows providing non-continuous elastomer-coated areas so as to save elastomer material.

In a further embodiment, the joint or, respectively, the thickened joint and the elastomer coating of the supporting layer consist of different materials. This embodiment can serve for producing the individual elements in each case from an elastomer which meets the respective requirements in terms of durability, weight, elasticity, and/or material resistance. Thus, it is possible to use expensive elastomer, which meets all requirements, only in such areas in which all these requirements in fact have to be met.

In another embodiment of the present seal, the elastomer of the coating of the supporting layer has a thickening in the circumferential direction (which runs around the passage opening), which is designed as a rib or a ridge. It is also provided that the joint or, respectively, the thickened joint from elastomer material is formed with a rib or a ridge. With additional ribs or ridges, the sealing function of the elastomer layer of the supporting layer and/or the joint can be controlled. The continuous ridge or the continuous rib is arranged here in such a manner that at least one screen or filter is surrounded by a respective ridge or a respective rib. The continuous ridge or the continuous rib can be present or not at certain areas of the seal. It is also provided to arrange a plurality of parallel ribs/ridges on at least one supporting layer so as to create a plurality of successively connected sealing barriers.

In an additional embodiment, the thickening and/or the rib or, respectively, the ridge has different heights and/or widths in the circumferential direction. This embodiment serves for compensating potential sealing gap differences or deviations and existing locally different pressings of the seal in terms of the sealing gap through a suitably adapted height of a ridge or a rib. This is in particular important in the area of the pressing, i.e., in the area of the screws/bolts.

In a further embodiment, the thickening and/or the rib or, respectively, the ridge has a height in the range of from 0.05-3 mm.

In another embodiment of the seal, at least one supporting layer comprises steel, low-carbon steel, galvanized low-carbon steel, stainless steel, aluminum or a thermoplastic or thermosetting polymer material. Preferably, the screen or, respectively, the filter is also made of steel, low-carbon steel, galvanized low-carbon steel, stainless steel, aluminum or a thermoplastic or thermosetting polymer material.

Preferably, an elastomer layer/elastomer coating is formed close to one of the edges of at least one supporting layer, wherein this elastomer layer is formed thicker than in the remaining seal so as to generate a lateral tightness. With a bead on the edge side it can be prevented that contaminants can penetrate from the outside into the area of the sealing gap which could result in corrosion in the in the area of the sealing surfaces. Such an edge bead can also be arranged in the area of inner edges such as, for example, at screw holes or bolt holes.

In a further embodiment of the present invention, each surface or each area of each supporting layer and/or of each screen or each filter which are or is covered with an elastomer layer is provided with at least one substance which improves adhesion of the elastomer layer on the supporting layer. With such a pretreatment, adhesion of the elastomer layer on the supporting layer or layers or, respectively, on the screen or screens or, respectively, on the filter or filters can be improved.

In one embodiment, at least one supporting layer is approximately 0.2 mm thick. This thickness is a suitable compromise for small static seals typically used in the automotive sector so as, on the one hand, to save material and, on the other, to achieve sufficient strength of the seal.

In another embodiment of the static seal, at least one supporting layer, one screen and/or filter has recesses which form a limit stop for compressing and improve anchoring the supporting layer, the screen and/or the filter. During the production of the seal, these recesses can serve for providing a limit stop for the mold. However, the recesses can also serve for aligning in each case the supporting layer, the screen or, respectively, the filter in the mold.

The elastomer can belong to the family of silicones. When using the present invention, a static seal with an inserted filter element can be produced in one work step, wherein the sealing parts made of elastomer consist of a single material. The thickness of the seal can be locally changed so as to ensure a contact pressure which is adapted to the potential deformation of the parts to be sealed with respect to one another.

According to a further aspect of the present invention, a method for producing a seal is provided. The method according to the invention comprises providing at least one supporting layer having at least one passage opening, and providing at least one screen or filter. The screen or, respectively, the filter is arranged in a position-oriented manner in the passage opening of the supporting layer, and subsequently, a joint from elastomer material is generated which connects the screen/the filter to the supporting layer in a position-oriented manner.

At least one supporting layer and at least one screen or filter are arranged together in such a manner that the spacing between a supporting layer and at least one screen or, respectively, at least one filter is small or, respectively, is so small that the spacing can be bridged by an elastomer. The supporting layer and the screen or the filter can be placed one after the other or together into a mold or template.

“Arranged in the passage opening of the supporting layer” is to be understood as placing the screen or the filter onto the supporting layer, or inserting the screen or the filter into an opening in the supporting layer, wherein direct contact between the supporting layer and the respective screen or, respectively, the respective filter is not necessary.

In one embodiment of the present invention, the joint made of elastomer material which connects the screen/the filter to the supporting layer in a position-oriented manner is generated by cold depositing an elastomer layer onto the supporting layer and the screen or, respectively, the filter, and by placing these elements into a heated mold for hot vulcanizing. Here, the at least one elastomer layer is deposited cold onto at least a portion of the screen or, respectively, filter, wherein at least a portion of the elastomer layer extends on the supporting layer and on the screen or, respectively, the filter. The supporting layer and the screen or, respectively, the filter and the elastomer layer are placed into a heated mold so that the elastomer layer is brought into the mold in such a manner that it connects the screen or, respectively, the filter to the supporting layer. In this mold, the elastomer is hot vulcanized so as to stabilize the joint.

At least one elastomer layer is cold-deposited onto at least a portion of the supporting layer and onto at least a portion of the screen or the filter. Here, at least a portion of an elastomer layer extends over the supporting layer and the screen or the filter and thereby bridges a potentially existing spacing between a supporting layer and a screen or, respectively, a filter.

Deviating from the above sequential arrangement, it is also possible to place the elastomer layer, the supporting layer and the screen or, respectively, the filter in any other sequential arrangement into the mold. For example, it is provided to place first a portion of the elastomer layer, then a supporting layer, then the screen or, respectively, the filter, and then a second portion of the elastomer layer into the mold. It is also provided to place first the supporting layer followed by the elastomer layer and the screen or, respectively, the filter into the mold.

It is also provided to first coat the support with elastomer, to place it into the tool or the mold, and only then to place the screen or, respectively, the filter into the tool so that shaping takes place by the elastomer flowing from the support to the screen/the filter thereby connecting the parts to one another.

In a further embodiment of the present invention, the joint made of elastomer material which connects the screen/the filter to the supporting layer in a position-oriented manner is produced in an alternative manner by placing the supporting layer and the screen or, respectively, the filter into a mold, closing the mold, and then introducing elastomer material into the mold by means of injection molding so that the elastomer material extends over a portion of the supporting layer and over a portion of the screen or filter and connects them to one another.

In an additional embodiment, the method further comprises applying a coating from elastomer onto at least one supporting layer.

In a further embodiment, the method further comprises applying bonding agents onto the at least one screen/the at least one filter and/or the at least one supporting layer before the joint from elastomer material is generated and/or the coating from elastomer is applied onto at least one of the supporting layers. According to another exemplary embodiment, the method further comprises applying one or a plurality of substances effecting adhesion of cold deposited elastomer on metal, on at least one supporting layer, on one screen and/or on one filter before the at least one cold elastomer layer is applied. The term “cold elastomer layer” relates to temperatures at which hot vulcanizing substantially does not take place yet.

Another embodiment of the method further comprises applying a continuous ridge or a continuous rib onto/into the elastomer coating of the at least one supporting layer and/or onto/into the joint made from elastomer material.

Preferably, the at least one continuous ridge or the one continuous rib is formed with a generally triangular cross-section, the height of which is ranges between 0.005 and 2.5 mm, and more preferred between 0.01 and 2 mm, and more preferred between 0.05 and 0.5 mm.

A generally triangular cross-section provides, on the one hand, a defined sealing edge and, on the other, sufficient support of this sealing edge. A ridge shaped in such a manner or a rib shaped in such a manner can also be used on slightly uneven or wavy sealing surfaces. Preferably, a plurality of ridges or ribs is arranged in a substantially concentric or parallel manner.

In another exemplary embodiment of the present invention, the at least one elastomer-covered supporting layer is placed into the mold in such a manner that close to the edge of at least the supporting layer, an elastomer layer is formed thicker than in the remaining seal so as to generate lateral tightness. It is also possible to design the mold and/or the elastomer layer in such a manner that during hot vulcanizing in the mold, a thickening is generated on the edge side.

The present invention is explained hereinafter by means of the description with reference to the enclosed schematic drawings which illustrate some selected examples of a static seal according to the invention.

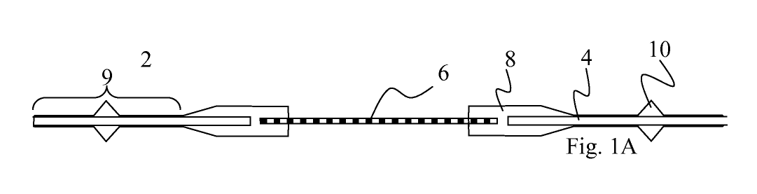

FIGS. 1A and 1B show a partial sectional view and a partial top view of a cut-out of the seal for a cylinder head cover.

FIGS. 1C and 1D show a partial sectional view and a partial top view of a cut-out of another embodiment of the seal according to the invention for a cylinder head cover.

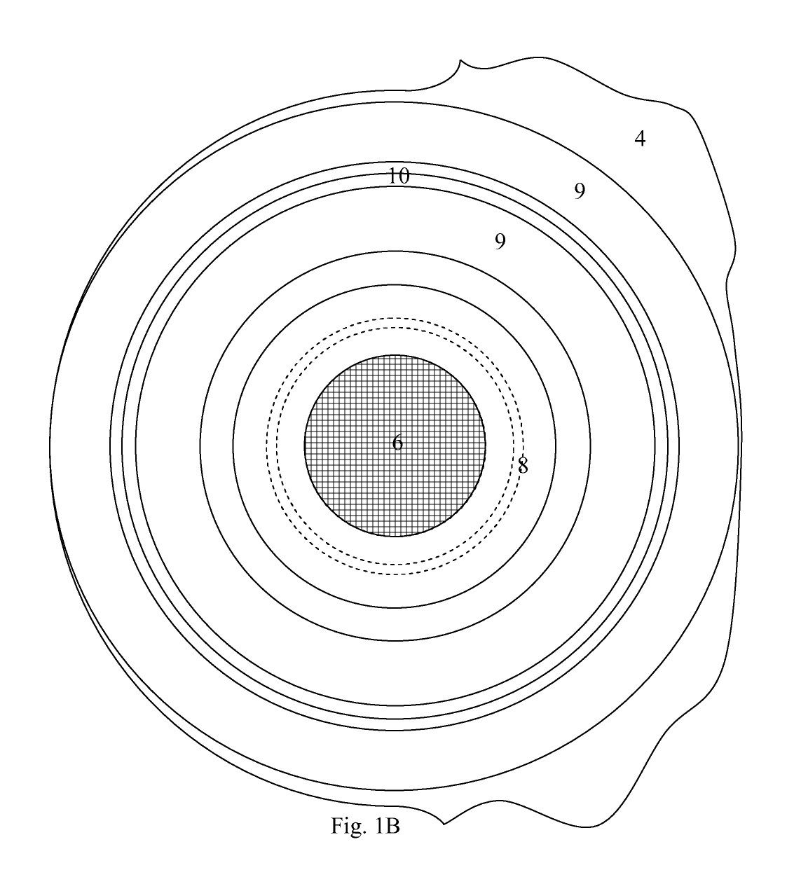

FIGS. 2A to 2E illustrate different other possible arrangements of supporting layers, screens or filters according to FIG. 1A.

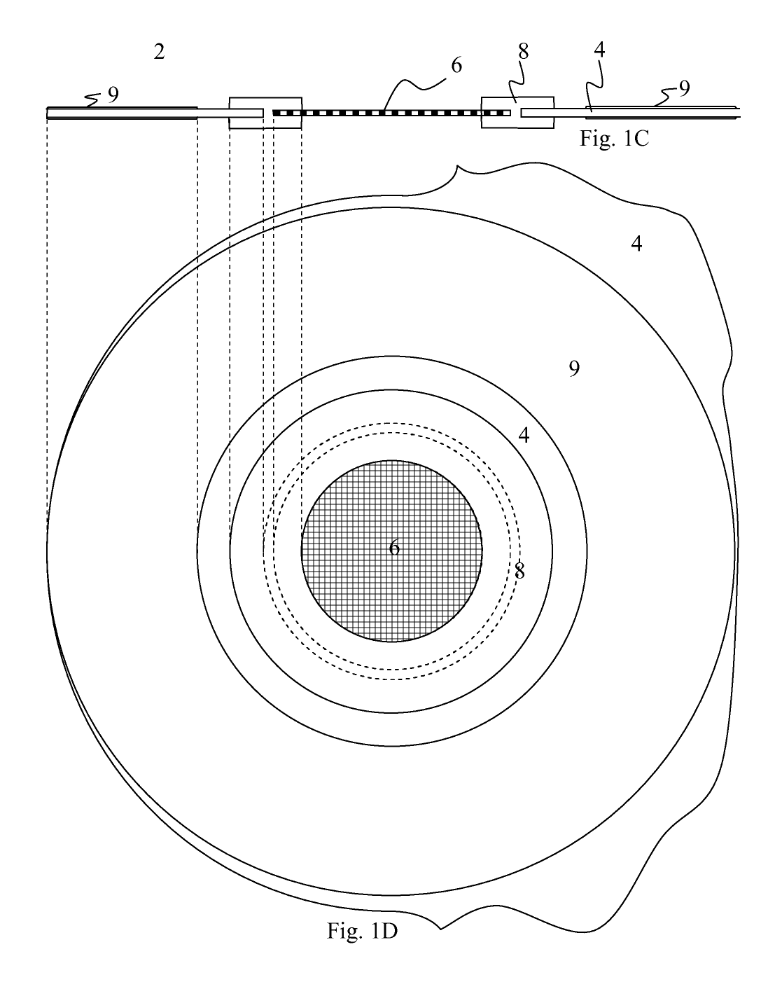

FIG. 3 shows a top view of a seal for a cylinder head cover, wherein a screen or a filter is integrated at the left edge.

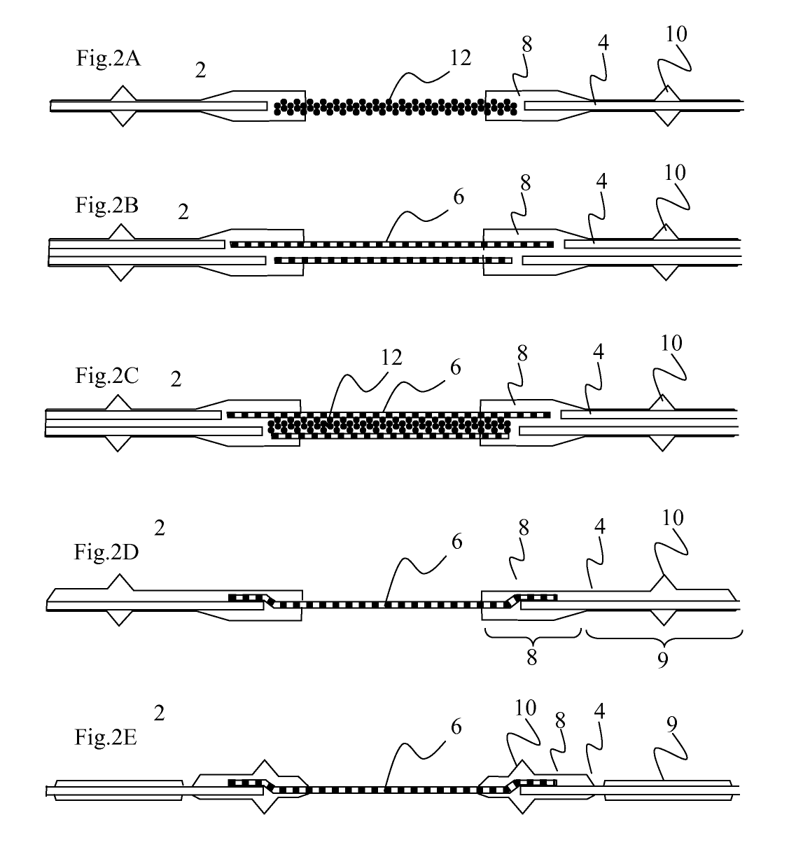

FIGS. 4A to 4D show schematically the individual steps for producing a seal according to the invention, based on the partial section of FIG. 1A.

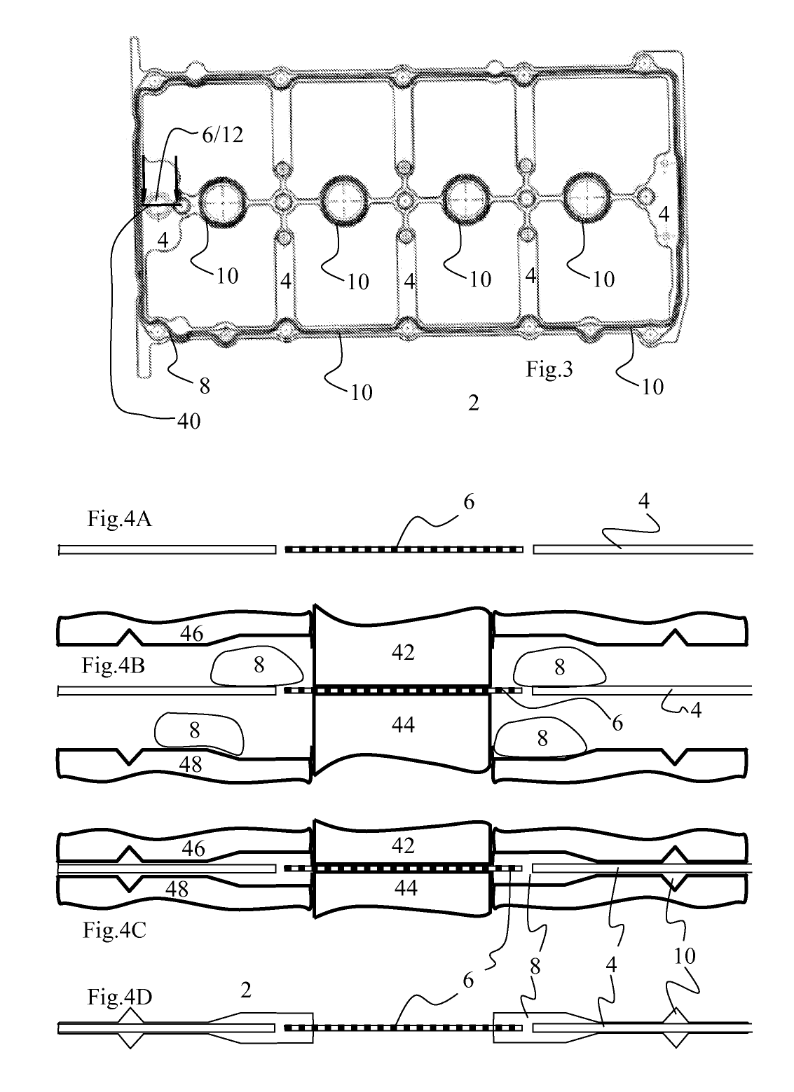

FIGS. 5A to 5D show schematically the individual steps for producing a seal according to the invention, based on the partial section of FIG. 1A.

In the figures as well as in the description, identical or similar reference numbers are used for identical or similar elements or components.

FIG. 1A shows a partial sectional view of a cut-out of a seal for a cylinder head cover for internal combustion engines. The seal comprises a supporting layer 4 which forms a core formed by a flat metal strip from galvanized steel. This strip is at least partially covered on its two sides with elastomer 8/9 such as, for example, silicone.

The thickness of the core is approximately 0.2 mm. The thickness of each elastomer layer varies between approximately 0 to 0.3 mm. The seal illustrated in the drawing has a passage opening covered by a screen 6. In the illustrated sectional view, the screen 6 is connected to the supporting layer 4 only through the joint 8 from elastomer. Next to the joint, the supporting layer is provided with a coating 9 from elastomer which is formed integrally with the joint 8. The thickness of the joint 8 or of the ridges 10 or ribs formed in the coating 9 can be varied so as to consider different pressings of the seal. The thickness of the joint 8 or the coating 9 or, respectively, the height of the ridges 10 or ribs can be selected so as to be at its greatest at the position at which the pressing is the lowest.

In the area of high pressing, the thickness of the seal can hardly be greater than the thickness of the supporting layer 4 while in the areas of low pressing, the thickness of the seal can be in the range of from 0.35 to 0.40 mm.

The coating 9 is provided with a closed ridge 10 or with a closed rib having a generally triangular cross-section. The height of the ridge 10 or the rib is or varies in the illustrated embodiment between 0.1 to 0.5 mm. The ridges 10 are arranged in consideration of the pressing exerted on the seal for ensuring an optimal tightness. Thus, it is possible to provide only a single ridge in the areas of high pressing, whereas in areas of low pressing, two or three parallel ridges 10 can be present forming sealing barriers arranged one behind the other. It is also provided to adapt the height of the ridges 10 to the local tightness requirements.

FIG. 1B shows a partial top view on a cut-out of the seal for a cylinder head cover. The individual features of FIG. 1B are connected to the corresponding features of FIG. 1A with dashed lines. The top view shows that the supporting layer 4 is almost completely covered by elastomer. The elastomer, on the one hand, forms a coating 9 of the supporting layer and, on the other, a joint 8 between the screen 6 and the supporting layer 4. Viewed together with FIG. 1A, it is also apparent that the screen 6 is not in direct contact with the supporting layer 4, but that these parts are connected to one another only through the joint 8. In the top view, the ridge 10 is illustrated by three concentric circles. A possible general view of a seal of a cylinder head cover is illustrated in FIG. 3.

FIG. 1C shows a partial sectional view of a cut-out of another embodiment of a seal according to the invention for a cylinder head cover for internal combustion engines. The seal comprises a supporting layer 4 which forms a core formed by a flat metal strip made of galvanized steel. This strip is at least partially covered on its two sides with elastomer 8/9 such as, for example, silicone.

The thickness of the core corresponds to the one of FIG. 1A, but with the difference that the coating of the supporting layer is not provided with a ridge. The seal illustrated in the drawing has a passage opening which is covered with a screen 6. In the illustrated sectional view, the screen 6 is connected to the supporting layer 4 only through the joint 8 from elastomer.

Next to said joint, the supporting layer is provided with a separate coating 9 from elastomer which is implemented separately from the joint 8. The thickness and the material of the joint 8 can differ from the ones in the coating 9. The thickness or, respectively, the height of the joint 8 and the coating 9 can be varied so as to consider different pressings of the seal.

The coating 9 is implemented as in FIG. 1C without a closed ridge 10.

FIG. 1D shows a partial top view on a cut-out of the seal for a cylinder head cover. The individual features of FIG. 1B are connected to the corresponding features of the FIG. 1A with dashed lines. The top view shows the supporting layer 4 between the coating 9 and the joint 8. The elastomer of the coating 9 can differ from the elastomer material forming the joint 8.

FIG. 2A illustrates an embodiment in which the screen of FIG. 1A is replaced by a filter 12. The remaining structure of the seal corresponds to FIG. 1A.

FIG. 2B shows a seal with two different supporting layers 4 arranged on top of one another so as to provide a thicker seal. In contrast to the structure of FIG. 1A, there are also two screens 6 arranged in the seal. The screens 6 have different diameters so that during a flow from above through the screen, said screen cannot be pulled out of the elastomer layer 8 because the diameter of the upper screen is larger than the respective recess in the lower supporting layer.

In terms of the structure, FIG. 2C corresponds substantially to the embodiment illustrated in FIG. 2B, wherein between the two screens 6, an additional filter 12 is arranged. Here, the filter 12 is supported by the screens 6.

FIG. 2D shows a seal, the structure of which corresponds substantially to the embodiment illustrated in FIG. 1A. However, in contrast to FIG. 1A, the screen 6 is larger than the corresponding recess or passage opening in the supporting layer. For centering, the screen 6 is provided with a half bead which centers the screen with regard to the passage opening in the supporting layer 4 when placing said screen in or on the supporting layer. Furthermore, this structure increases the strength of the joint between the supporting layer 4 and the screen 6.

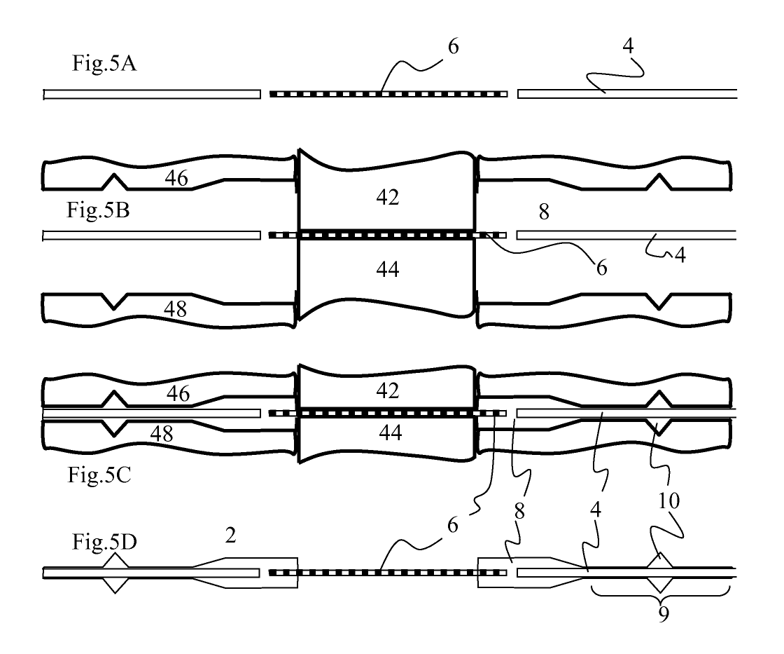

FIG. 2D shows a cross-section through a seal, the structure of which corresponds substantially to the embodiment illustrated in FIG. 10 or, respectively, 1D. However, in contrast to FIG. 1A, the screen 6 is larger than the corresponding recess or passage opening in the supporting layer 4. For centering, the screen 6 is provided with a half bead which centers the screen with regard to the passage opening in the supporting layer 4 when placing said screen in or on the supporting layer. Furthermore, this structure increases the strength of the joint between the supporting layer 4 and the screen 6.

Furthermore, the seal of FIG. 2D is provided with ridges or ribs which are arranged on the joint 8. In the illustrated embodiment, sealing the passage opening is achieved by the elastomer of the joint 8 and the ridges 10.

It is also provided to attach ridges on the joint 8 and also on the coating 9.

FIG. 3 shows a top view of a seal for a cylinder head cover, wherein a screen or filter is integrated at the left edge. FIGS. 1A and 2A to 2D can also correspond to a sectional view along the line 40 of FIG. 3. FIG. 3 clearly shows further ridges 10. FIG. 3 also shows areas in which the supporting layer is not covered by elastomer. In FIG. 3, other areas of the supporting layer are also covered with elastomer 8.

FIGS. 4A to 4D show schematically the individual steps for producing a seal according to the invention, based on the partial section of FIG. 1A.

FIG. 4A illustrates a supporting layer 4 and a screen 6 arranged close to one another.

In FIG. 4b, an elastomer in the form of a bead is applied on at least a portion of a supporting layer 4 and on at least a portion of the screen 6. The supporting layer 4 is placed together with the screen 6 into a mold 42, 44, 46, 48. The piston-shaped parts 42 and 44 are first lowered onto the screen 6 so as to prevent elastomer from penetrating into the meshes or pores of the screen when closing the other parts 46, 48 of the mold. Then, the mold parts 46 and 48 are closed.

In FIG. 4C, the mold parts 46 and 48 are closed and have evenly distributed the elastomer between the mold parts 42, 44, 46, 48. The closed mold is then heated so as to hot vulcanize the elastomer.

After hot vulcanizing, the mold is opened and the finished seal can be removed. The finished seal of FIG. 4D corresponds to the cut-out of FIG. 1A. The elastomer layer of the seal of FIG. 4D is vulcanized and due to the at least one supporting layer 4, the seal has a strength which is only slightly lower than the strength of a supporting frame seal.

The elastomer layers 8 can be applied in one work step, and fastening the screen 6 in the seal 2 is also carried out in one work step. The adhesion between the elastomer 8 and the supporting layer can be improved by means of adhesive substances. Through the insertion into a heated mold, first the elastomer layers are molded and then vulcanized. It is also possible to improve this fastening by a mechanical anchoring, namely by means of apertures which are introduced on both sides into the supporting layer 4, wherein these apertures establish not only the mechanical anchoring of the polymer layers, but serve also as limit stop for compressing.

FIGS. 5A to 5D show schematically the individual steps for producing a seal according to the invention, based on the partial section of FIG. 1A.

In FIG. 5A, a supporting layer 4 and a screen 6 is provided, wherein the screen 6 is arranged in a passage opening of the supporting layer 4.

In FIG. 5B, the supporting layer 4 and the screen 6 are placed into a mold and are aligned with one another.

In FIG. 5C, the mold 42, 44, 46, 48 is closed around the supporting layer 4 and the screen 6 and elastomer material is injected into the mold.

By injection molding the elastomer in the mold, the joint 8 and the coating 9 of the supporting layer were formed with a circumferential ridge 10. The piston-shaped parts 42 and 44 were lowered prior to injection molding so as to prevent elastomer from penetrating into the meshes or pores of the screen during molding.

It is also possible to use a mold consisting of only two parts.

After the elastomer has cooled down and solidified, the mold is opened for removing the finished seal.

The finished seal of FIG. 5D corresponds to the cut-out of FIG. 1A. However, it is clear that with (modified) methods of the FIGS. 4A to 5D, all seal cross-sections also can be produced as illustrated in the FIGS. 2A to 2E or as they arise from combinations of the features as illustrated in the FIGS. 1A to 3. It is explicitly pointed out here that all possible seals resulting from combinations of features as disclosed in the description and in the Figures are also to be considered as being disclosed.

It is also to be considered as being disclosed to combine the screen of FIG. 2D with a plurality of supporting layers as illustrated in FIG. 2B.

The invention enables a great simplification of the existing technology by providing a seal with a screen or filter element which can be produced in a simple manner in one work step. Through the supporting layer which can be produced from an inexpensive material, a sufficient mechanical strength of the seal is made possible. The elastomer layers on the supporting layer ensure the sealing function of the seal. The thickness of the elastomer layers can be varied so as to adapt said layers to the pressure loads with regard to the surroundings of the seal.

1. A seal, comprising:
at least one supporting layer having at least one passage opening, wherein the supporting layer has a coating from elastomer;
at least one screen or one filter;
wherein the at least one screen or the at least one filter is arranged in at least one of the passage openings;
wherein the at least one screen or the at least one filter is connected to the at least one supporting layer through a joint from elastomer material and is held in the passage opening in a position-oriented manner;
wherein the joint from elastomer material is thickened and serves for sealing the passage opening; and
wherein the thickened joint from elastomer is formed integrally with the elastomer coating of the supporting layer.

2. A seal, comprising:
at least one supporting layer having at least one passage opening, wherein the supporting layer has a coating from elastomer;
at least one screen or one filter;
wherein the at least one screen or the at least one filter is arranged in at least one of the passage openings;
wherein the at least one screen or the at least one filter is connected to the at least one supporting layer through a joint from elastomer material and is held in the passage opening in a position-oriented manner;
wherein the joint from elastomer material is thickened with respect to the coating and serves for sealing the passage opening; and
wherein the thickened joint is formed separately from the elastomer coating of the supporting layer.

3. The seal according to claim 1, wherein the thickened joint and the elastomer coating of the supporting layer consist of different materials.

4. The seal according to claim 1, wherein the elastomer coating of the supporting layer has a thickening in the circumferential direction which is designed as a rib or as a ridge, or that the joint from elastomer material is designed with a rib or a ridge.

5. The seal according to claim 4, wherein the thickening and/or the rib or the ridge has different heights and/or widths in the circumferential direction.

6. The seal according to claim 4, wherein the thickening and/or the rib or the ridge has a height in the range of from 0.05-3 mm.

7. The seal according to claim 1, wherein the at least one supporting layer comprises steel, low-carbon steel, carbonized low-carbon steel, stainless steel, aluminum or a thermoplastic or thermosetting polymer material.

8. A method for producing a seal, comprising:
providing at least one supporting layer having at least one passage opening;
applying a coating from elastomer onto the at least one supporting layer;
providing at least one screen or one filter;
arranging the at least one screen or the at least one filter in a position-oriented manner in at least one passage opening of the supporting layer in a mold;
generating a joint from elastomer material, which said joint connects the at least one screen/the at least one filter in a position-oriented manner to the at least one supporting layer;
wherein the steps of applying the coating from elastomer onto the at least one supporting layer and generating the joint from elastomer material to connect, the at least one screen/the at least one filter in a position-oriented manner to the at least one supporting layer, comprises:
cold depositing at least one elastomer layer onto at least a portion of the supporting layer and onto at least a portion of the screen or the filter, wherein at least a portion of the elastomer layer extends over the supporting layer and over the screen or over the filter;
placing the at least one supporting layer and the at least one screen or filter as well as the at least one elastomer layer into a heated mold so that the at least one elastomer layer is brought into the mold in such a manner that it connects the screen or the filter to the supporting layer; and
hot vulcanizing the elastomer in the mold.

9. A method for producing a seal, comprising:
providing at least one supporting layer having at least one passage opening;
applying a coating from elastomer onto the at one supporting layer;
providing at least one screen or one filter;
arranging the at least one screen or the at least one filter in a position-oriented manner in at least one passage opening of the supporting layer in a mold;
generating a joint from elastomer material, which said joint connects the at least one screen/the at least one filter in a position-oriented manner to the at least one supporting layer;
Wherein the steps of applying the coating from elastomer onto the at least one supporting layer and generating the joint from elastomer material, to connect the at least one screen or the at least one filter in a position-oriented manner to the at least one supporting layer, comprises:
placing the at least one supporting layer and the at least one screen or filter into a mold and closing the mold;
introducing and molding elastomer material in the mold by means of injection molding so that the elastomer material extends over a portion of the at least one supporting layer and over a portion of the screen or the filter and connects them to one another.

10. The method according to claim 8, further comprising:
applying a bonding agent onto the at least one screen or the at least one filter and/or the at least one supporting layer before the joint from elastomer material is generated and/or the coating from elastomer is applied onto the at least one supporting layer.

11. The method according to claim 8, further comprising:
applying a continuous ridge or a continuous rib onto or into the elastomer coating of the at least one supporting layer.

12. The method according to claim 11, wherein the at least one continuous ridge or one continuous rib is formed with a generally triangular cross-section, the height of which is between 0.005 and 2.5 mm and more preferred between 0.01 and 0.5 mm.

13. The seal according to claim 2, wherein the thickened joint and the elastomer coating of the supporting layer consist of different materials.

14. The seal according to claim 2, wherein the elastomer coating of the supporting layer has a thickening in the circumferential direction which is designed as a rib or as a ridge, or that the joint from elastomer material is designed with a rib or a ridge.

15. The seal according to claim 14, wherein the thickening and/or the rib or the ridge has different heights and/or widths in the circumferential direction.

16. The seal according to claim 14, wherein the thickening and/or the rib or the ridge has a height in the range of from 0.05-3 mm.

17. The seal according to claim 2, wherein the at least one supporting layer comprises steel, low-carbon steel, carbonized low-carbon steel, stainless steel, aluminum or a thermoplastic or thermosetting polymer material.

18. The method according to claim 9, further comprising:
applying a bonding agent onto the at least one screen or the at least one filter and/or the at least one supporting layer before the joint from elastomer material is generated and/or the coating from elastomer is applied onto the at least one supporting layer.

19. The method according to claim 9, further comprising:
applying a continuous ridge or a continuous rib onto or into the elastomer coating of the at least one supporting layer.

20. The method according to claim 19, wherein the at least one continuous ridge or one continuous rib is formed with a generally triangular cross-section, the height of which is between 0.005 and 2.5 mm and more preferred between 0.01 and 0.5 mm.
